(19) United States
(12) Patent Application Publication
(10) Pub. No.: US 2019/0235496 A1
(43) Pub. Date: Aug. 1, 2019

(54) METHOD FOR MANAGING AN AUTOMATED SYSTEM CONTROLLED BY AN OPERATOR AND AN AUTOMATIC CONTROLLER, ASSOCIATED AUTOMATED SYSTEM

(71) Applicant: INSTITUT SUPERIEUR DE L'AERONAUTIQUE ET DE L'ESPACE, Toulouse Cedex (FR)

(72) Inventors: Frédéric Dehais, Toulouse (FR); Patrice Labedan, Escorneboeuf (FR)

(73) Assignee: INSTITUT SUPERIEUR DE L'AERONAUTIQUE ET DE L'ESPACE, Toulouse Cedex (FR)

(21) Appl. No.: 16/342,742

(22) PCT Filed: Oct. 18, 2017
(86) PCT No.: PCT/FR2017/052863

§ 371 Date: Apr. 17, 2019

(30) Foreign Application Priority Data
Oct. 24, 2016 (FR) 1660286

(51) Int. Cl. G05D 1/00; G01C 23/00; B64D 43/00; B64D 45/00; G06F 3/01

(52) U.S. Cl. CPC G05D 1/0061; G01C 23/00; G06F 3/013; B64D 45/00; B64D 43/00

(57) ABSTRACT

The disclosure provides methods for managing an automated system having a display and adapted to be controlled by a human operator and by at least one automatic controller. The methods include triggering a condition associated with a parameter of the automated system, displaying the parameter on the display in a first display zone, automatically changing the automatic controller between a first state and a second state subsequent to the triggering the condition, displaying the second state on the display in a second display zone, detecting, by a gaze tracking device of the human operator and after displaying the parameter and displaying the second state, a plurality of viewed zones of the display that are viewed by the human operator within a predetermined time interval, and verifying whether the plurality of viewed zones comprises at least the second display zone and the first display zone.

### 1. TECHNICAL FIELD OF THE INVENTION

The invention concerns a method for managing an automated system. In particular, the invention concerns a method for managing an automated system of a vehicle, in particular an aircraft.

### 2. TECHNICAL BACKGROUND

Operator-controlled systems, including sensitive systems, i.e. systems that receive increased attention for safety reasons, such as vehicles (e.g. rail, land or sea vehicles, aircraft, etc.) or nuclear power plant control panels for example, comprise a multitude of interaction buttons and indicators light to allow interaction with the operator. To simplify the operator's management of these systems, part of this management is automated and managed according to parameters calculated or measured by the system.

In particular, in the aeronautical field, aircrafts have an automatic piloting mode that allows tasks to be performed without the intervention of the pilot (the operator).

However, in these automated management situations, one of the problems encountered is to ensure that if the system changes state, the operator notices the change of state. In the case of aircraft, the problem is becoming more and more critical in view of the increased complexity of automatic piloting.

In addition, if these state changes can be triggered directly by the operator, in which case they are expected by the operator, they can also be triggered by an additional action of the operator which leads to changes in the value of parameters which in turn leads to a state change, or they can be executed automatically by the system without action by the operator.

In the latter two cases, it is therefore essential to ensure that the operator has clearly perceived the changes of states. To do this, solutions have been proposed to track the operator's gaze (the so-called gaze-tracking or eye-tracking method), to ensure that the pilot has seen a visual element of the system's control panel indicating the change of state.

However, this solution is not sufficient. Indeed, when a change of state is made when the operator has not directly caused this change of state, it is possible that the operator does not understand why the change of state was made. This type of situation can lead to erratic behavior on the part of the operator who, wanting to try to return the system to the initial state without understanding the reasons for the change of state, does not know or misunderstands the procedure to be applied to return to the initial state. These conflicts between the operator and the automatic manager can escalate and lead to serious accidents or incidents. In particular, in an aircraft, with the pilot and autopilot sharing the aircraft piloting management, these conflicts can lead to dangerous problems with the aircraft's trajectory.

The inventors therefore sought a solution to ensure that the operator had complete control over the system he controls, even in the presence of automatic management of the system in parallel, which can carry out changes of states.

### 3. GOALS OF THE INVENTION

The invention aims to overcome at least some of the disadvantages of known managing methods and automated systems.

In particular, the invention aims to provide, in at least one embodiment of the invention, a method for managing that ensures that the operator is aware of the change of state of the automated system that he controls and that he has a good understanding of the system and in particular the reasons that led to this state.

The invention also aims to provide, in at least one embodiment, a managing method that allows alerting the human operator when he is not aware of the change of state of the automated system that he controls and the reasons that led to this state.

The invention also aims to provide, in at least one embodiment, a method and management device that can be used in an aircraft piloted by a human pilot and an autopilot.

### 4. PRESENTATION OF THE INVENTION

To do so, the invention concerns a method for managing an automated system comprising a display and adapted to be controlled by a human operator and by at least one automatic controller comprising a predetermined number of states and a set of conditions allowing to switch from one state to another, the automatic controller being in only one state at a time, the method comprising:
a step of triggering a condition associated with a parameter of the system,
a step of displaying said parameter of the system on the display in a first display zone of the display, called the parameter zone,
a step of automatic change of state of the automatic controller between a first state of the automatic controller and a second state of the automatic controller subsequent to the triggering of the condition,
a step of displaying said second state on the display in a second display zone of the display, called second state zone,

characterized in that it further comprises:
a step of detecting, by an operator's gaze tracking device and after the display of the parameter and the display of the second state, the zones of the display that are looked at by the human operator within a predetermined time interval, called the zones looked at,
a step of verifying that the zones looked at comprise at least the second state zone and the parameter zone.

A method according to the invention therefore allows, by verifying that the zones looked at by the human operator comprise at least the display zone associated with the second state (i.e. the new state of which the operator must be aware) and the zone associated with the parameter related to the condition that triggered the transition to this second state. Thus, in addition to knowing that the human operator is aware of the new state (the second state), the method ensures that the human operator is aware of the condition that caused the second state.

The method can of course be implemented for several operators or groups of operators, in order to verify that at least one operator is aware of the new state and the condition that caused this second state. For example, in an aircraft, the pilot and co-pilot train two operators.

The display is a screen or a plurality of screens or a set of indicator lights or dials allowing visual interaction with the operator.

The parameter zone and the second state zone are deduced and selected by analyzing the correspondence between the parameter or state wanted to be seen by the operator and the display zone normally provided for in the display of this parameter or state. This correspondence is recorded, for example, in the form of a table, list, etc. A parameter display or second state display means the display of a visual element indicating the parameter or state. For example, a speedometer for displaying the speed, a light information in a form of text or a drawing giving the name of the current state or the value of a parameter, an indicator light on or off on which the name of the state or parameter is written, etc. Of course, the parameter can be mapped to several display zones and the step of verifying verifies that the zones looked at comprise each parameter zone associated with the parameter.

The step of displaying the parameter of the system can be performed after the condition has been triggered (or fulfilled) (for example, a value of a parameter exceeding a threshold will require an indicator light to be illuminated), or before the condition has been triggered (for example, if the condition is related to an exceeding of a certain speed, the speed can be a parameter that is already displayed by the system before the condition is triggered).

A state of an automatic controller is for example a value or a set of values of a set of parameters. An automatic controller consists, for example, of a memory comprising the current state and all the states and conditions or transitions or events allowing the passage from one state to another. The automatic change of state of the automatic controller consists, for example, in a change of value from the automatic controller in the memory to the new state as soon as a condition is met.

The condition is associated with a parameter by a value of this parameter (e. g. value of a sensor), by a state of this parameter (e. g. threshold state exceeded by the value of the parameter, threshold state not reached by the value of the parameter), by a logical combination of different values or parameter state, by comparing the parameter to a value, etc. More generally, the condition can be any type of condition known in a finite state automatic controller used for industrial purposes (e. g. industrial program automatic controller type). In addition, the condition can be linked to another separate automatic controller, for example if the other automatic controller is in a particular state, the condition is validated and the main automatic controller changes state.

Of course, the condition can be validated by several parameters displayed on several parameter zones and the verification step verifies that the zones looked at comprise each parameter zone associated with each parameter.

Advantageously, the detection step comprises a follow-up of the gaze, which consists in particular in a follow-up of the ocular movement which can be completed by a follow-up of the human operator's head and/or body in order to determine the zones of the display looked at by the human operator.

Advantageously and according to the invention, if the zones looked at comprise at least the second state zone and the parameter zone, the method comprises a step of controlling, by the operator's gaze tracking device, that the operator makes an eye movement between the second state zone and the parameter zone.

According to this aspect of the invention, this step validates that the zones looked at are indeed distinct zones and that the second state zone and the parameter zone are not identical zones.

Advantageously, the method according to the invention further comprises, when the step of verifying concludes that the zones looked at do not comprise at least the second state zone and the parameter zone:
a step of creating a text alert message comprising at least a first text obtained from the second state and a second text obtained from the triggered condition.

According to a first variant of the invention, the method according to the invention further comprises a step of displaying said alert message on the display.

According to a second variant of the invention, the method according to the invention also comprises a step of voice synthesis of said text alert message by a sound emission device.

According to other variants of the invention, when the step of verifying concludes that the zones looked at do not comprise at least the second state zone and the parameter zone, an audible warning is issued, or a combination of audible, voice or text display alert is issued.

According to this aspect of the invention, this step alerts the human operator to the change of state and warns him of the condition that triggered the change of state. The text alert message is obtained, for example, by concatenation or combination of descriptive texts. This step is only performed when it is apparent that the human operator has not looked at the parameter and second state zones, i.e. is not aware of the change of state or is not aware of the condition that caused the change of state. Alerting the operator only when the method considers that the change of state is not understood and not at each transition, limits the number of alerts submitted to the human operator and only warns him if his lack of awareness of the evolution of the states of the automatic controller is detected.

According to a variant of the invention, the text message comprises a third text obtained from the first state. The addition of a text message from a text obtained from the first state improves the understanding of the change of state.

The invention also concerns an automated system adapted to be controlled by a human operator and by at least one automatic controller comprising a predetermined number of states and a set of conditions allowing to switch from one state to another, the automatic controller being in only one state at a time, the system comprising:
means to manage the automatic controller, adapted to automatically change the state of the automatic controller between a first automatic controller state and a second automatic controller state when a condition associated with a parameter of the system is triggered,
a display, adapted to display the parameter of the system in a first display zone of the display, called the parameter zone, and the second state of the automatic controller in a second display zone of the display, called the second state zone,
an operator's gaze tracking device, adapted to detect zones of the display looked at by the human operator within a predetermined time interval, called the zones looked at,
means for verifying that the zones looked at comprise at least the second state zone and the parameter zone.

The invention also concerns an aircraft comprising an automated system according to the invention, said system being controlled by an autopilot and adapted to be piloted by a human pilot.

The invention also concerns a managing method, an automated system and an aircraft characterized in combination by all or some of the characteristics mentioned above or below.

### 5. LIST OF FIGURES

Other purposes, characteristics and advantages of the invention will appear in the following description, which is given for information purposes only and refers to the annexed figures in which:

FIG. 1 is a schematic view of an aircraft cockpit display screen,

FIGS. 2, 3, 4 and 5 are schematic views of an aircraft cockpit display screen and a state of transition diagram during the implementation of a method according to an embodiment of the invention,

FIG. 6 represents a managing method according to an embodiment of the invention.

### 6. DETAILED DESCRIPTION OF AN EMBODIMENT OF THE INVENTION

The following embodiments are examples. Although the description refers to one or more embodiments, this does not necessarily mean that each reference refers to the same embodiment, or that the characteristics apply only to one embodiment. Simple characteristics of different embodiments can also be combined to provide other embodiments. On the figures, scales and proportions are not strictly respected for illustration and clarity purposes.

The embodiments represented in this description relate to the implementation of the method and management device of an aircraft (in particular an airplane) controlled by a pilot. However, the managing method and device can be implemented in any type of system controlled by a human operator and at least partially by an automatic controller and allowing interactions with the operator through visual elements on a display.

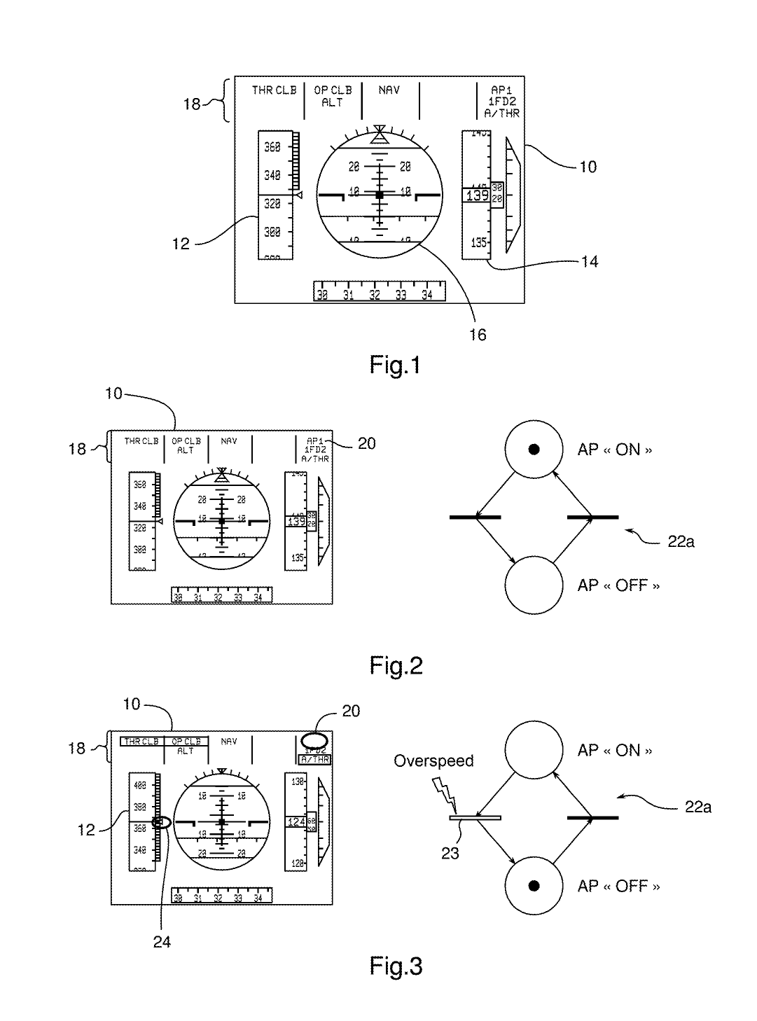

FIG. 1 is a schematic representation of a display 10 of a system controlled by a human operator and at least one automatic controller. In particular, the display 10 is a screen installed in an aircraft piloted by a human pilot and an autopilot managing several automatic controllers each in a single state at a time.

The display 10 displays several elements, including speed, via a speedometer 12, altitude, via an altimeter 14, trim, via an artificial horizon 16, as well as the states of the various automatic controllers managed by the autopilot in a graphical interface called FMA 18 for Flight Mode Annunciator.

The FMA 18, in this embodiment, comprises various information, distributed in different columns, here from left to right:
the aircraft's thrust modes, for example here “THR CLB” for thrust climb, meaning the “climb thrust” state,
the vertical modes, for example here “OP CLB” for open climb, meaning the “fast climbing” state,
horizontal modes, for example here “NAV” for navigation, meaning the state in which the aircraft follows the flight plan,
the autopilot state in the last column, for example here “AP1” for AutoPilot, meaning that autopilot is activated.

In this embodiment, the displayed information is gathered in a single screen, but according to other embodiments of the invention, the display comprises several screens, dials or indicator lights to display the information to the pilot. In particular, the speedometer, altimeter, artificial horizon and FMA can be placed in different displays or dials depending on the aircraft.

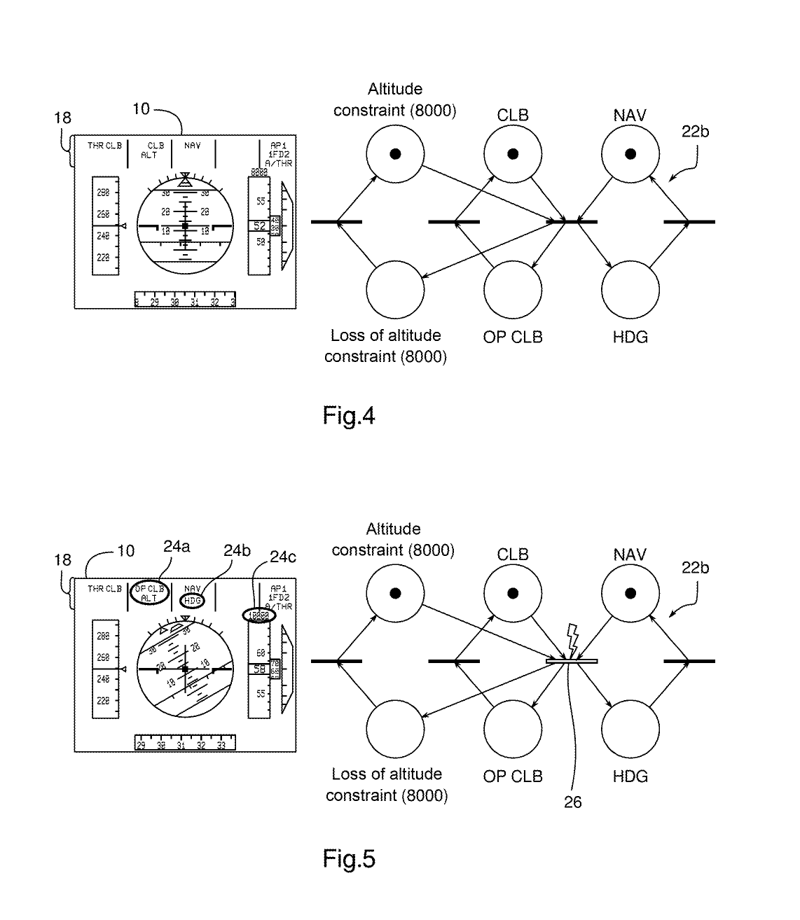

FIGS. 2, 3, 4 and 5 are each a schematic view of a display and a state of transition diagram representative of an automatic controller during different phases of the methods for managing according to an embodiment of the invention.

FIGS. 2 and 3 provide a first example. The aircraft situation described in FIG. 2 is a situation in which autopilot is activated, as indicated by the presence of a text “AP1” in an FMA 18 display zone 20 of the display 10. The activated autopilot corresponds to a state of an automatic controller 22 comprising two states, a first AP state “ON” in which the autopilot is activated, and a second AP state “OFF” in which the autopilot is deactivated. In the situation shown in FIG. 2, the automatic controller is in the AP state “ON”.

FIG. 3 describes a situation in which the aircraft is in over speed.

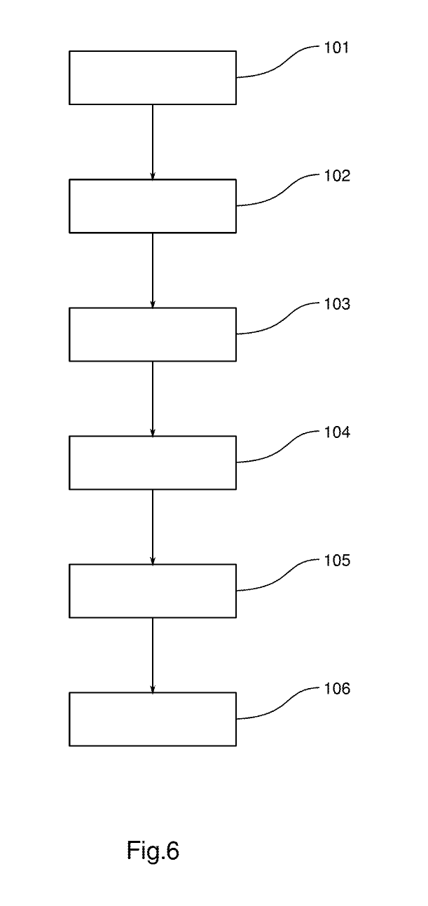

This over speed will initiate a method for managing according to an embodiment of the invention, as shown in FIG. 6. According to a first step 101 of triggering, the over speed will trigger a condition 23 associated with the automatic controller. Over speed is related to the aircraft speed parameter that is displayed in a second display step 102 by the display 10 in the display zone related to the speedometer 12. According to another embodiment, the “over speed” parameter can be displayed independently of the speed, for example by means of a specific indicator light.

The automatic controller 22, by triggering condition 23 associated with aircraft over speed, will move into a third step 103 of automatic state change, from the first AP state “ON” to the second AP state “OFF”. This change of state is displayed in a fourth display step 104 in the display 10, in particular via the absence of text “AP1” in the display zone 20, which was present in the previous situation shown in FIG. 2, thus indicating the change of state.

These first steps are already known from the prior art.

Following the change of state and the display of the parameter and the second state, an operator's gaze tracking device makes it possible, in a fifth detection step 105, to detect display zones looked at by the human operator within a predetermined time interval, called the zones looked at. In a sixth verifying step 106, the system verifies that the zones looked at comprise at least the second state zone and the parameter zone.

The zones looked at are zones that have been looked at by the operator for a sufficient period of time without interruption to consider that the zone is being looked at. These criteria are known in the use of gaze tracking devices.

The predetermined time interval corresponds to a minimum time in which it is desired that the human operator has become aware of the change of state and the condition that led to the change of state (by looking at the parameter zone), which can be set at ten seconds for example.

Following this predetermined time interval, if the verification indicates that the human operator has not looked at either the second state zone or the parameter zone, or has looked at the second state zone but not the parameter zone, it can be considered that he has not understood the reasons for the change of state. Thus, the method may comprise an additional step in which a text alert message is created comprising at least information about the first state, the second state and the condition that triggered the switch from one state to another. For example, in the case presented, the message may take the form: “The autopilot has changed from AP state “ON” (first state information) to AP state “OFF” (second state information) because overspeed (condition information)”.

Before displaying this message, the method may perform additional analyses to reinforce the presumptions that the human operator does not understand the autopilot behavior.

In particular, a first analysis can be an analysis of the ballistics of the eye, making it possible to decompose the operator's ocular behavior in order to characterize its degraded attention states. The measurement of ocular activity makes it possible to detect alterations in attention by differentiating the phases between attention and vision. As a simplified example for the purpose of fixing ideas, we can calculate the relationship between exploration time (jerky movements of the eye) and operating time (fixing). By extrapolation, this relationship provides a good indication of the understanding measure of the pilot. For example, if it appears that the exploration times of the operators are greater than a reference value or that the fixing times are less than another reference value, the assumptions that the human operator does not understand the autopilot behavior increase.

A second analysis is used to detect situations in which:
the change of state occurred without direct pilot action on the autopilot interfaces,
the actions of the pilot on the autopilot interface have no effect.

These situations lead to an increase in the presumptions that the human operator does not understand the autopilot behavior.

A second example is shown in FIGS. 4 and 5. The aircraft situation presented in FIG. 4 is a situation in which the aircraft is climbing, following its navigation and having an altitude constraint of 8000 feet, as indicated respectively by the presence of a text “CLB” and “NAV” in FMA 18 display zones and above the altimeter 14 on the display 10. The activated autopilot corresponds to a state of several automatic controllers 22, each including two states: a first automatic controller comprising a first Altitude Stress state in which an altitude stress is fixed and a second Altitude Stress Loss state in which no altitude stress is fixed, a second automatic controller comprising a first CLB state in which the aircraft is climbing and a second OPCLB state in which the aircraft is in another vertical mode, and a third automatic controller comprising a first NAV state in which the aircraft follows its navigation and a second HDG (heading hold signifying straight running) state in which the aircraft follows its heading. In the situation shown in FIG. 4, the automatic controllers are in the Altitude Stress, CLB and NAV state.

FIG. 5 shows a situation in which the pilot, in order to perform an avoidance maneuver, changes the aircraft's heading.

The change of heading initiated by the pilot will initiate a managing method according to an embodiment of the invention, as shown in FIG. 6. According to a first trigger step 101, the heading change will trigger a condition 26 associated with the third automatic controller causing the change from NAV state to HDG state. This is the objective desired by the operator, so it is not necessary to verify that he is aware of this single change of state.

However, the change of state of the third state of the automatic controller also leads to a change of state of the second automatic controller: change of vertical mode from CLB state to OPCLB state. This change in vertical mode results in a change of state of the first automatic controller: loss of altitude constraint leading to an ascent of the aircraft to 10000 feet of altitude. The condition for the change of state of the first automatic controller linked to altitude is therefore a change of state of another automatic controller.

Thus, to verify that the operator is well aware of the loss of altitude constraint, it is necessary to verify that he is looking at:
the display zone 24c related to the aircraft's target altitude (10000 feet),
the condition leading to this loss of altitude constraint, which is the change of vertical mode in the display zone 24a (OPCLB),
the condition leading to this vertical mode change, which is the change of heading mode displayed in the display zone 24b (HDG).

1. A method for managing an automated system having a display and adapted to be controlled by a human operator and by at least one automatic controller having a predetermined number of states and a set of conditions allowing the automatic controller to switch from one state to another, the automatic controller being in one predetermined state at a time, the method comprising:
triggering a condition associated with a parameter of the automated system;
displaying the parameter of the automated system on the display in a first display zone of the display;
automatically changing the automatic controller between a first state and a second state subsequent to the triggering the condition;
displaying the second state on the display in a second display zone of the display;
detecting, by a gaze tracking device of the human operator and after displaying the parameter and displaying the second state, a plurality of viewed zones of the display that are viewed by the human operator within a predetermined time interval; and
verifying whether the plurality of viewed zones comprises at least the second display zone and the first display zone.

2. The method according to claim 1, further comprising controlling, by the gaze tracking device after verifying whether the plurality of viewed zones comprises at least the second display zone and the first display zone, that the human operator makes an eye movement between the second display zone and the first display zone,
wherein verifying whether the plurality of viewed zones comprises at least the second display zone and the first display zone comprises verifying that a positive identification condition exists in which the plurality of viewed zones comprise at least the second display zone and the first display zone.

3. The method according to claim 1,
further comprising creating a text alert message comprising at least a first text obtained from the second state and a second text obtained from the condition,
wherein verifying whether the plurality of viewed zones comprises at least the second display zone and the first display zone comprises verifying that a negative identification condition exists in which the plurality of viewed zones do not comprise at least the second display zone and the first display zone.

4. The method according to claim 3, further comprising displaying the text alert message on the display.

5. The method according to claim 4, further comprising delivering a voice synthesis of the text alert message by a sound emission device.

6. An automated system adapted to be controlled by a human operator and by at least one automatic controller having a predetermined number of states and a set of conditions allowing the automatic controller to switch from one state to another, the automatic controller being in one state at a time, the automated system comprising:
a manager adapted to automatically change a state of the automatic controller between a first automatic controller state and a second automatic controller state when a condition associated with a parameter of the automated system is triggered;
a display, adapted to display the parameter of the automated system in a first display zone of the display, and adapted to display the second state of the automatic controller in a second display zone of the display;
a gaze tracking device, adapted to detect a plurality of viewed zones of the display viewed by the human operator within a predetermined time interval; and
a verifier adapted to verify whether the plurality of viewed zones comprises at least the second display zone and the first display zone.

7. An aircraft comprising an automated system according to claim 6, wherein the human operator is a human pilot and the automatic controller is an autopilot system.
